(19) United States
(12) Patent Application Publication
(10) Pub. No.: US 2017/0138321 A1
(43) Pub. Date: May 18, 2017

(54) ASSEMBLY FOR A HEAT ENGINE AIR CIRCUIT

(71) Applicant: Valeo Systemes de Controle Moteur, Cergy Saint Christophe (FR)

(72) Inventor: Mathieu Lallemant, Maisons-laffitte (FR)

(73) Assignee: Valeo Systemes de Controle Moteur, Cergy Saint Christophe (FR)

(21) Appl. No.: 15/323,613

(22) PCT Filed: Jul. 6, 2015
(86) PCT No.: PCT/FR2015/051860

§ 371 Date: Jan. 3, 2017

(30) Foreign Application Priority Data
Jul. 4, 2014 (FR) 1456437

(51) Int. Cl. F02M 26/58

(52) U.S. Cl. CPC F02M 26/58

(57) ABSTRACT

An assembly (1), comprising:
a first pipe (11),
a second pipe (12), forming a bypass for a portion of the first pipe (11), comprising a compressor (15),
a flap, in one of the second pipe (12) and said portion, movable between:
   a first position allowing the fluid to circulate predominantly in said portion, and
   a second position allowing the fluid to circulate predominantly in the second pipe (12),
a maintaining member configured to bring or keep the flap (3) in the first position, the flap (3) going from the first to the second position when the pressure variation generated by the compressor (15) exceeds a predefined value,
   the wall of the second pipe (12) and the flap (3) being configured to define a passage section, said section increasing as soon as possible when said flap (3) closes off said portion.

The present invention relates to an assembly for a heat engine air circuit.

The invention in particular, but not exclusively, applies to the automotive field, the heat engine then making it possible to propel the vehicle.

The assembly comprises a first pipe and a second pipe forming a bypass for a portion of the first pipe, the first and second pipes being able to be traveled by a fluid. The assembly further comprises a switching system for the fluid making it possible to vary the distribution of the fluid between the portion of the first pipe and the second pipe.

It is known to provide the switching system with an actuator making it possible to vary the distribution of the fluid between the portion of the first pipe and the second pipe. Such an actuator nevertheless has a cost and requires an appropriate control law.

The invention aims to resolve this drawback while providing the desired distribution of fluid between the portion of the first pipe and the second pipe.

According to one aspect, the invention achieves this using an assembly for a heat engine air circuit, comprising:
a first pipe able to convey fluid,
a second pipe extending between an inlet in the first pipe and an outlet in the first pipe, so as to form a bypass for a portion of the first pipe, the second pipe comprising a pressure variation source,
a switching flap for the fluid in one of the second pipe and said portion of the first pipe, the flap being movable between:
   a first position allowing the fluid to circulate predominantly in the portion of the first pipe, and
   a second position allowing the fluid to circulate predominantly in the second pipe,
a maintaining member exerting a torque configured to bring or keep the switching flap in the first position,
   the flap going from the first to the second position when the pressure variation generated in the second pipe by the source exceeds a predefined value, this pressure variation then exerting a torque on the switching flap allowing this change to the second position, despite the torque exerted by the maintaining member,
   the wall of the second pipe at the switching flap and the flap being configured to define a passage section for the fluid circulating in the second pipe, said section increasing as soon as possible when said flap reaches a third position in which it closes off said portion of the first pipe.

The above assembly takes advantage of the presence of the pressure variation in the second pipe to modify the position of the flap. Owing to the configuration of the flap, the wall of the second pipe at the flap, the passage section for the fluid circulating in the second pipe increases as soon as possible when the flap reaches a position in which it closes off the portion of the first pipe. When the flap is in an intermediate position between the first and second positions, such a configuration makes it possible to prevent fluid circulating in the second pipe from also being able to circulate in the portion of the first pipe, i.e., in the direction going from the outlet in the first pipe toward the inlet in the first pipe.

The passage section of the fluid circulating in the second pipe may be constant when the flap is in a position comprised between the first and third positions, the passage section being comprised between 0 and 50% of the section of the second pipe, in particular between 2 and 40%, for example between 3 and 10%.

The flap may include:
a first part arranged to close off part of the second pipe, when the flap is in the first position,
a second part, separate from the first part, arranged to close off the portion of the first pipe when the flap is in the third position.

The switching flap can be arranged at the outlet of the second pipe into the first pipe.

The switching flap can be arranged at the portion of the first pipe.

The switching flap can be arranged downstream of the pressure variation source.

The switching flap can be arranged at the outlet of the second pipe into the first pipe, the flap being arranged downstream of the pressure variation source.

The switching flap can be arranged at the junction between the second pipe and the first portion of the first pipe, the flap being arranged downstream of the pressure variation source.

In the first position of the flap, the first part can partially close off the outlet into the first pipe. The fluid can thus circulate predominantly in the first pipe. The term “predominantly” used above must be understood as meaning both “more than half of the flow rate of the fluid in the first pipe upstream from the inlet of the second pipe into the first pipe” and “the entire flow rate of the fluid in the first pipe upstream of the inlet of the second pipe into the first pipe.”

In the second position, the fluid can use the second pipe. In this second position, all of the fluid can thus use the second pipe, with the exception of any leaks that may exist at the second part of the flap.

The second part of the flap can be arranged to define, with the wall of the second pipe, said passage section.

The second part of the flap can be arranged to define, with the wall of the first pipe, said passage section.

The first and second parts of the flap can pivot around a single pivot axis of the flap. This single axis makes it possible to simplify the design of the flap while allowing synchronized movement of the first and second parts.

The first and second parts of the flap can be angularly offset around the pivot axis.

The first and second parts of the flap can be axially offset along the pivot axis. This axial offset makes it possible to isolate the first and second pipes, which results in limiting leaks at the flap.

The first and second parts of the flap can be angularly offset around the pivot axis and axially along said axis.

The first and second parts of the flap can be planar walls offset by an angle comprised between 10° and 160°, in particular between 50° and 120°, the angle being measured in a plane orthogonal to the pivot axis.

The first and second parts of the flap can alternatively each be a planar wall, these walls being aligned relative to one another.

The first and second parts of the flap can alternatively each be a curved wall.

The assembly may be provided with no actuator causing the flap to go from the first position to the second position. An actuator refers to a means dedicated to generating a force on the flap, the means being separate from the maintaining member and the pressure variation source.

The assembly may comprise a single flap to switch the fluid into one of the second pipe and said portion of the first pipe.

The pressure variation source is in particular an electric compressor arranged in the second pipe. Such an electric compressor makes it possible to supply the heat engine with compressed air quickly when the heat engine operates with reduced power or when an abrupt load increase occurs. This second compressor is then for example a turbocompressor associated with the heat engine, to resolve the significant response time of the turbocompressor, also called “turbolag.”

The first and second pipes may be part of the intake circuit of the heat engine.

The electric compressor may be arranged downstream of an outlet of an exhaust gas recirculation (EGR) loop.

The electric compressor may be arranged upstream of, downstream of or parallel to the compressor of the turbocompressor.

The first and second positions may be extreme positions for the movement of the flap.

The flap may stop against an abutment in at least one of the first and second positions.

The maintaining member may be chosen so as to be appropriate for the pressure variation source, in order to allow the flap to be kept in the first position as long as the pressure variation source is generating pressure in the second pipe strictly lower than the predefined pressure value.

The maintaining member may be chosen so as to be appropriate for the pressure variation source, in order to allow the flap to go to the second position when the pressure variation generated in the second pipe by the source exceeds the predefined value.

Independently of or in combination with the preceding, the surface of the first part at least partially closing off the second pipe may be chosen so as to allow the flap to go to the second position once the predefined pressure variation value generated by the pressure variation source is reached.

The first and second pipes can extend in parallel directions, the outlet and the inlet being formed by bent portions of the second pipe.

In all of the preceding, the maintaining member can be an elastic return member. This return member can make it possible to return the flap from the second position to the first position when the pressure variation generated in the second pipe decreases, in particular becomes lower than the predefined value.

The elastic return member can comprise a spring. The pressure variation source and at least one of the stiffness and the empty position of the spring are for example chosen such that the torque exerted on the flap due to the existence of the pressure variation can assume a value above the value of the torque exerted by the spring on this flap. The switching flap can then go from the first position to the second position, the aforementioned mismatch between the torque values remaining until the flap reaches the second configuration.

In all of the preceding, the fluid may be a gas, such as air, exhaust gases recirculated from the engine exhaust, or a mixture of air and recirculated exhaust gases.

In all of the preceding, the electric compressor may comprise a variable reluctance motor, for example having a rated power comprised between 1 and 10 kW, for example 5.5 kW for a rotation speed of 70,000 RPM.

The assembly is for example integrated into a motor vehicle.

The invention will be better understood upon reading the following description of non-limiting example embodiments thereof, as well as upon examining the appended drawing, in which:

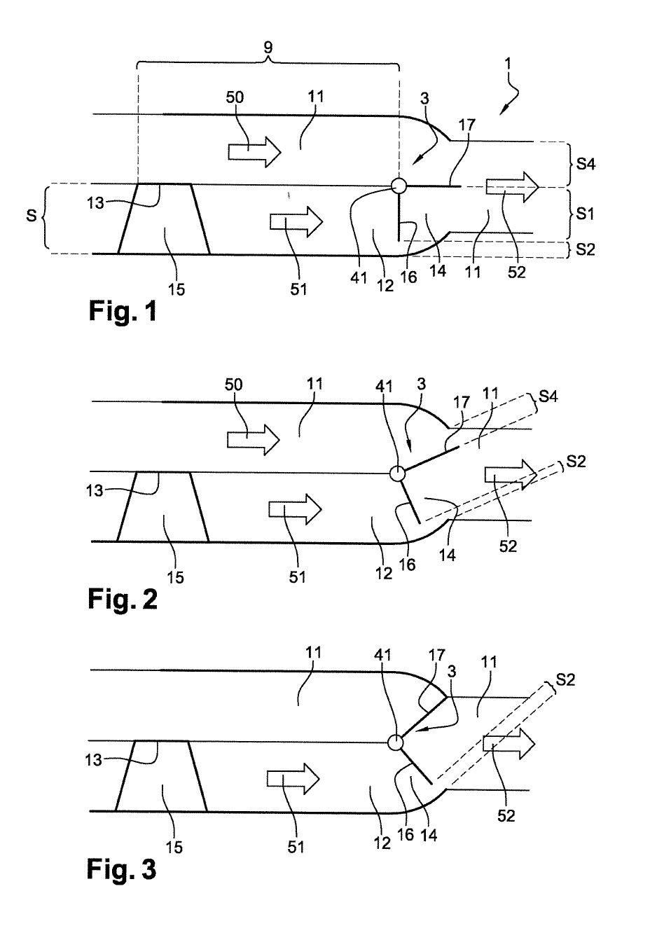

FIGS. 1 to 4 schematically show an example assembly according to the invention, the flap respectively being in the first position, an intermediate position between the first and third position, the third position, and the second position,

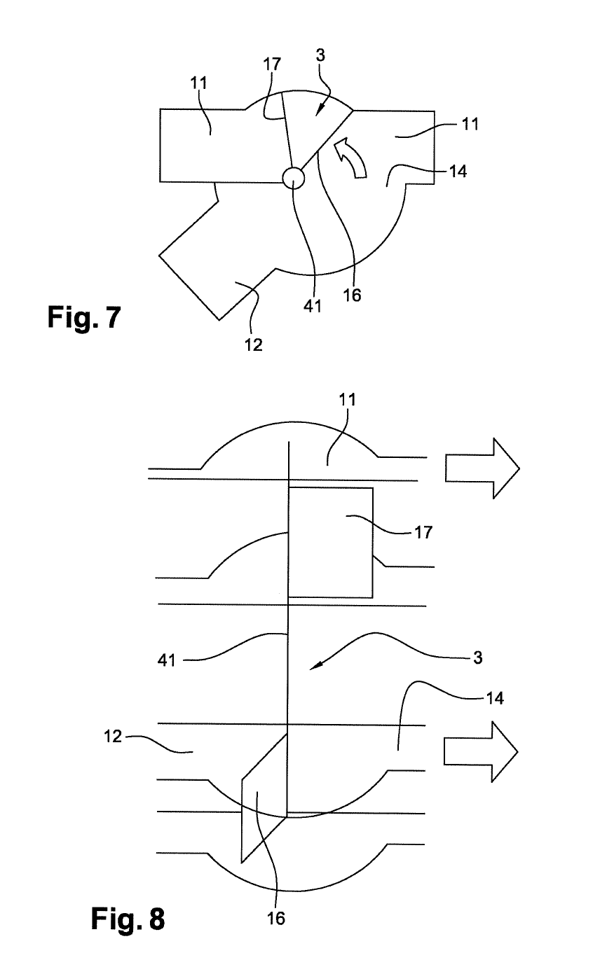

FIGS. 5 to 7 schematically show another example assembly according to the invention, the flap respectively being in the first position, the third position, and the second position, and

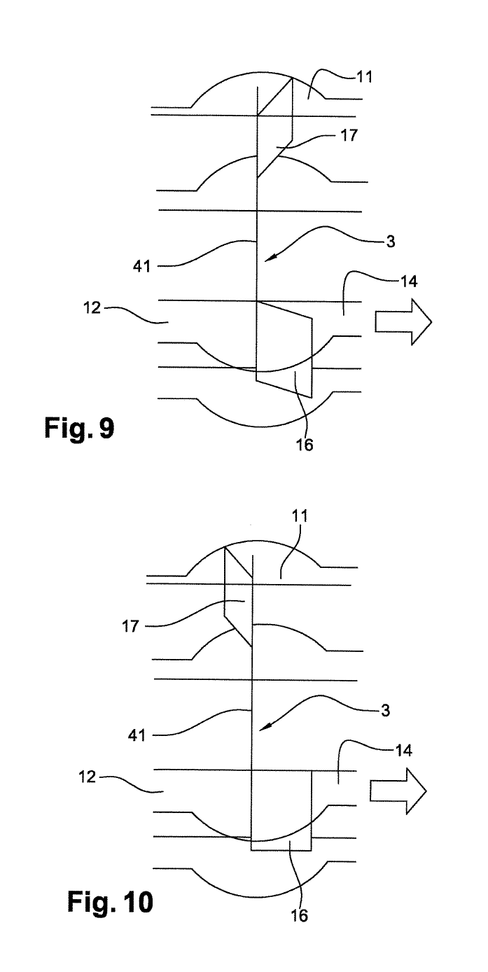

FIGS. 8 to 10 schematically show another example assembly according to the invention, the flap respectively being in the first position, the third position, and the second position.

FIG. 1 schematically shows an example assembly 1 for a heat engine air circuit. This is for example a vehicle heat engine, for example working with gasoline or diesel. In the example, the assembly 1 is part of the intake circuit of the heat engine. It is for example arranged downstream of the outlet in the intake circuit of an exhaust gas recirculation (EGR) loop.

The assembly 1 may also be associated with a mechanical compressor that is part of the turbocompressor and is not shown in the figures.

The assembly 1 comprises:
a first pipe 11 able to convey fluid,
a second pipe 12 extending between an inlet 13 in the first pipe 11 and an outlet 14 in the first pipe 11.

As shown in FIG. 1, the first 11 and second 12 pipes extend in parallel directions, the outlet 14 and the inlet 13 being formed by bent portions of the second pipe.

As shown in FIG. 1, the second pipe 12 thus forms a bypass for a portion 9 of the first pipe 11. Reciprocally, the portion 9 of the first pipe 11 makes it possible to bypass the second pipe 12.

The second pipe 12 comprises an electric compressor 15 forming a pressure variation source.

This electric compressor 15 makes it possible to assist the turbocompressor, in particular when it is operating with reduced power or when an abrupt load increase occurs. In the considered example, this electric compressor 15 comprises a variable reluctance motor.

In the considered example, the first pipe II comprises a pivoting switching flap 3 arranged at the outlet 14 in the first pipe 11.

The flap 3 is kept in or brought into position as shown in FIG. 1 by a spring, not shown, forming a maintaining member. The spring exerts a maintaining force whose value is related to the value of its stiffness.

When the flap 3 is in the position as shown in FIG. 1, it is in a position subsequently called “first position.” This first position is an idle position for the flap.

In the example of FIGS. 1 to 4, the flap 3 includes a first part 16 and a second part 17 connected by a pivot axis 41. The first 16 and second 17 parts are angularly offset by an angle of about 90° around the pivot axis 41. This pivot axis 41 is situated substantially at the junction between the second pipe and the portion of the first pipe 11, at the outlet 14. In the first position of the flap 3, the first part 16 extends in the second pipe 12. In the considered example, this first part 16 has a reduced section SI relative to the section S of the second pipe 12, such that it allows the existence of a passage section S2 for the fluid between the first part 16 and the second pipe 12 at the outlet 14. The first part 16 for example extends perpendicular to the direction along which the second pipe extends at the outlet 14, such that the first part 16 closes off part of the second pipe 12.

In the first position of the flap 3, the second part 17 extends in the first pipe 11, for example parallel to the portion 9 of the first pipe 11, such that the passage section of the fluid is maximal, in the portion 9 of the first pipe 11.

In the first position of the flap 3, the fluid flowing in the first pipe 11 upstream of the second pipe 12 flows predominantly in the portion 9 of the first pipe 11, bypassing the second pipe 12.

The term “predominantly” used above must be understood as meaning “more than half of the flow rate of the fluid in the first pipe 11 upstream from the inlet 13 of the second pipe 12.”

In the considered example, in this first position of the flap 3, the electric compressor 15 is operating at a rotation speed of about 5000 RPM, called “idling speed.” This idling speed makes it possible to avoid an excessive reaction time to reach higher rotation speeds, for example a speed of 50,000 RPM. At this idling speed, part of the fluid flowing in the first pipe 11 upstream of the second pipe 12 flows in the second pipe 12 via the passage section for the fluid existing between the first part 16 of the flap 3 and the second pipe 12 at the outlet 14. The spring exerts a maintaining force on the flap 3, this force being greater than the torque exerted by the pressure generated by the electric compressor in the second pipe 12. In this first position of the flap 3, the path traveled by the fluid is depicted by arrows 50, 51 and 52. The fluid flowing in the first pipe 11 upstream of the second pipe 12 flows predominantly in the portion of the first pipe 11, along arrow 50, and for the rest, in the second pipe 12, along arrow 51. The fluid flowing in the first pipe 11, downstream of the outlet 14, shown by arrow 52, is equal to the sum of the fluids depicted by arrows 50 and 51.

FIG. 2 shows the assembly 1 of FIG. 1, the flap 3 having pivoted around the axis 41, for example in the trigonometric direction, from the first position. The flap here is in a position in which the first part 16 of the flap 3 extends in the second pipe 12 and forms the passage section S2 for the fluid with the second pipe 12 at the outlet 14, the passage section S2 being the same as when the flap is in the first position, as shown in FIG. 1. The second part 17 closes off part of the portion 9 of the first pipe 11. In this position, the flap 3 closes off part of each of the first and second pipes. In this position, the electric compressor 15 has a speed higher than that which it has when the flap 3 is in the first position, i.e., in the considered example, a speed strictly greater than 5000 RPM.

FIG. 3 shows the assembly 1 of FIG. 1, the flap 3 having pivoted around the axis 41, for example in the trigonometric direction, from the position as illustrated in FIG. 2. The flap is shown here in a third position in which the first part 16 of the flap 3 extends in the second pipe 12 and forms the passage section S2 for the fluid with the second pipe 12 at the outlet 14, the section S2 being the same as when the flap is in one of the first or second positions, as shown in FIGS. 1 and 2, respectively. In the considered example, the second part 17 completely closes off the portion 9 of the first pipe 11. In this third position, the fluid coming from the second pipe 12, depicted by arrow 51, cannot circulate toward the portion 9 of the first pipe 11 and thus flows completely in the first pipe 11, downstream of the outlet 14, i.e., along arrow 52. The fluid is thus completely bypassed in the second pipe 12.

The position of the flap 3 as shown in FIG. 2 is thus an intermediate position between the first and third positions, while the flap pivots in the same rotation direction from the idle position toward the third position.

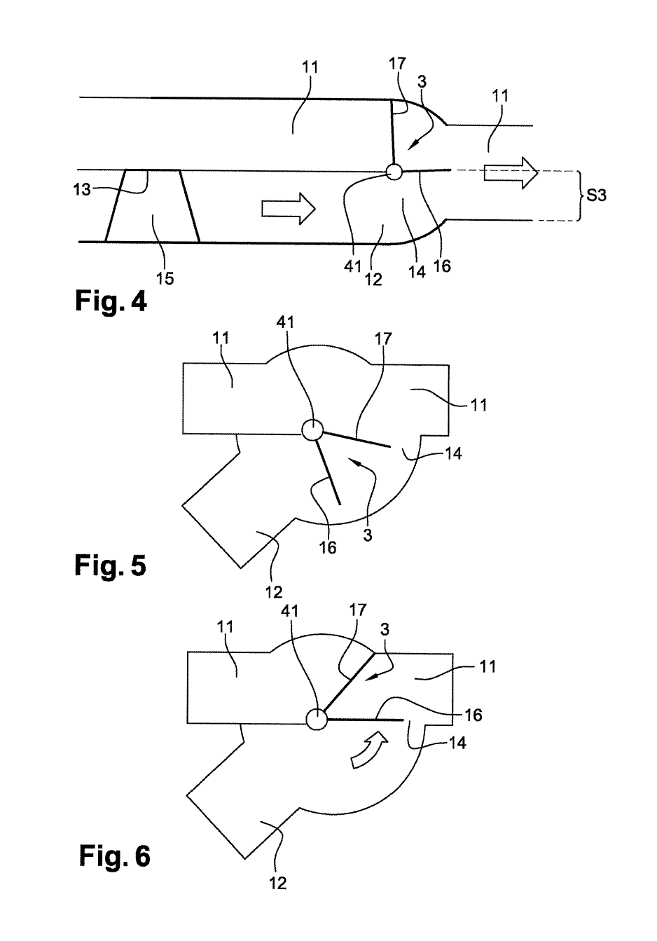

FIG. 4 shows the assembly 1 of FIG. 1, the flap 3 having pivoted around the axis 41, for example in the trigonometric direction, from the position as illustrated in FIG. 3. Here, the flap 3 is in a second position in which the first part 16 extends in the first pipe 11, for example parallel to the portion of the first pipe 11, such that the passage section S3 of the fluid is maximal, in the second pipe 12. The second part 17 for example extends perpendicular to the axis along which the portion 9 of the first pipe 11 extends at the outlet 14, such that the first part 17 completely closes off the portion 9 of the first pipe 11.

In this second position, the fluid coming from the second pipe 12, depicted by arrow 51, cannot circulate toward the portion 9 of the first pipe 11 and thus flows completely in the first pipe 11, downstream of the outlet 14, i.e., along arrow 52. The fluid is thus completely bypassed in the second pipe 12. Unlike the position shown in FIG. 3, in this second position of the flap, the passage section of the fluid circulating in the second pipe 12 is maximal.

As will now be described, the invention makes it possible to change the position of the flap 3 from the first position described above in reference to FIG. 1 to the third position described above in reference to FIG. 3, then to the second position described above in reference to FIG. 4. The passage from the first position to the second position is obtained by pivoting the flap 3 in the same rotation direction and without using a dedicated actuator to pivot the flap 3, in particular without using an electric, pneumatic or electromagnetic actuator.

The assembly 1 goes from the first to the third, then to the second position when the electric compressor 15 generates a pressure variation exceeding a predefined value to provide compressed air to the heat engine. In this example, this pressure variation corresponds to a vacuum at the inlet 13 and an overpressure at the outlet 14. In the considered example, this pressure variation is obtained when the compressor 15 goes from a rotation speed of 5000 RPM to a rotation speed of 70,000 RPM.

Due to this pressure variation, a force is exerted on the flap 3 by the first part 16 extending across from the second pipe 12 when the flap 3 is in the first position.

When the force exerted on the flap 3 due to the overpressure generated by the electric compressor 15 becomes higher than a predefined value, which in the described example is greater than the return force exerted on said flap by the maintaining member, the latter pivots around the axis 41, such that the flap 3, starting from the idle position, finds itself in the second position by passing through the third position.

The electric compressor 15 thus acts as an actuator causing the flap 3 to go from the first position to the second position.

When the pressure variation generated by the electric compressor 15 exerts a force on the flap 3 lower than the return force exerted by the corresponding maintaining member, the flap 3 is returned to the first position.

During the movement of the switching flap 3, leaving the first position and before reaching the third position, there is:
a passage section S4 for the fluid at the second part 17 of the flap 3 and the wall of the portion 9 of the first pipe 11, and
a passage section S2 for the fluid at the first part 16 of the flap 3 and the wall of the second pipe 12, the latter section being constant when the flap 3 goes from the first position to the third position.

The pressure variation generated by the compressor 15 results in lowering the fluid flow rate circulating in the portion 9 and increasing the fluid flow rate circulating in the second pipe 12. Just before the flap 3 reaches the third position, the fluid flow rate circulating in the portion 9 is substantially zero and the fluid flow rate circulating in the second pipe 12 is equal to the fluid flow rate circulating in the first pipe 11 downstream from the outlet 14. Thus, no fluid can circulate from the outlet 14 toward the portion 9. Consequently, the assembly 1 is arranged to allow this flow rate circulating in the second pipe 12 to be completely aspirated by the heat engine.

When the flap 3 goes from the third position to the second position, the portion 9 is closed off and no fluid can circulate from the outlet 14 toward the portion 9. The compressor 15 can thus generate a pressure variation in the second pipe 12 of a nature to create an overpressure in the first pipe 11 downstream of the outlet 14 without the risk of this overpressure allowing the fluid to circulate in the portion 9.

FIGS. 5 to 7 show another example assembly 1, the flap 3 respectively being in the first position, the third position, and the second position. This other example assembly 1 differs by the value of the angle between the parts of the flap.

FIGS. 8 to 10 show another example assembly 1, the flap 3 respectively being in the first position, the third position, and the second position.

This other example assembly 1 differs by the value of the angle between the parts of the flap and the axial position of the parts of the flap along the pivot axis of the flap. In this example embodiment, the pivot axis 41 extends both at the portion 9 of the first pipe 11 and at the second pipe 12, downstream of the electric compressor 15.

The first 16 and second 17 parts are planar walls offset by an angle of about 45°, the angle being measured between the projections of the parts 16 and 17 of the flap, in a plane orthogonal to the pivot axis 41.

The first 11 and second 12 pipes extend, at the flap 3, in parallel directions. The outlet and the inlet are not shown in FIGS. 8 to 10, and are formed by bent portions of the second pipe.

The wall of the portion 9 of the first pipe 11 at the switching flap 3 forms a cylinder portion of revolution and the second part 17 of the flap 3 comes into contact with said wall at the cylinder portion, when the flap 3 closes off the portion 9 of the first pipe 11.

The wall of the second pipe 12 at the switching flap 3 forms a cylinder portion of revolution and the first part 16 of the flap 3 forms the passage section for the fluid with the wall of the second pipe 12.

The expression “comprising a” must be understood as being synonymous with the expression “comprising at least one,” unless otherwise specified.

1. An assembly for a heat engine air circuit, comprising:
a first pipe able to convey fluid;
a second pipe extending between an inlet in the first pipe and an outlet in the first pipe, to form a bypass for a portion of the first pipe, the second pipe comprising a pressure variation source;
a switching flap for the fluid in one of the second pipe and said portion of the first pipe, the switching flap being movable between:
a first position allowing the fluid to circulate predominantly in the portion of the first pipe, and
a second position allowing the fluid to circulate predominantly in the second pipe; and
a maintaining member exerting a torque configured to bring or keep the switching flap in the first position,
the flap going from the first to the second position when the pressure variation generated in the second pipe by the source exceeds a predefined value, this pressure variation then exerting a torque on the switching flap allowing this change to the second position, despite the torque exerted by the maintaining member,
the wall of the second pipe at the switching flap and the switching flap being configured to define a passage section for the fluid circulating in the second pipe, said section increasing as soon as possible when said flap reaches a third position which closes off said portion of the first pipe.

2. The assembly according to claim 1, the switching flap being arranged downstream of the pressure variation source.

3. The assembly according to claim 1, the flap including:
a first part arranged to close off part of the second pipe, when the flap is in the first position,
a second part, separate from the first part, arranged to close off the portion of the first pipe when the flap is in the third position.

4. The assembly according to claim 3, the first part being arranged to define said passage section with the wall of the second pipe.

5. The assembly according to claim 2, the first and second parts pivoting around a single pivot axis of the flap.

6. The assembly according to claim 5, the first and second parts being angularly offset around the pivot axis.

7. The assembly according to claim 5, the first and second parts being planar walls offset by an angle comprised between 50° and 120°, the angle being measured in a plane orthogonal to the pivot axis.

8. The assembly according to claim 1, being provided with no actuator causing the flap to go from the first position to the second position.

9. The assembly according to claim 1, comprising a single switching flap to switch the fluid into one of the second pipe and said portion of the first pipe.

10. The assembly according to claim 1, comprising an electric compressor arranged in the second pipe.
